(19) United States
(12) Patent Application Publication
(10) Pub. No.: US 2026/0019424 A1
(43) Pub. Date: Jan. 15, 2026

(54) Using Codes to Provide More Secure Authentication

(71) Applicant: MICRO FOCUS LLC, WILMINGTON, DE (US)

(72) Inventors: DOUGLAS MAX GROVER, RIGBY, ID (US); MICHAEL F. ANGELO, HOUSTON, TX (US)

(73) Assignee: MICRO FOCUS LLC, WILMINGTON, DE (US)

(21) Appl. No.: 18/769,377

(22) Filed: Jul. 10, 2024

(51) Int. Cl. H04L 9/40

(52) U.S. Cl. CPC H04L 63/105; H04L 63/0807; H04L 63/0823

(57) ABSTRACT

A request is received, from a user, to access a first level authentication service. A code associated with the user is generated that causes a redirection to a second level authentication service. The generated code associated with the user is sent. The user is authenticated based on a valid authentication credential of the user. Authenticating the user based on the valid authentication credential is accomplished at one of: the first level authentication service or the second level authentication service. At the first level authentication service, a message is received from the second level authentication service. The message sent from the second level authentication service is sent in response to the second level authentication service validating the generated code associated with user. In response to authenticating the user based on receiving the message from the second level authentication service, access is allowed, by the user to a resource.

### FIELD

The disclosure relates generally to providing authentication services and particularly to providing more secure authentication services that uses codes.

### BACKGROUND

Currently there are simple solutions that allow a user to access a website using a scanned code. For example, a scanned Quick Response (QR) code on a product may be used to register the product under a warranty. While using a scanned code is convenient for accessing resources that requires minimal security, scanned codes are not used in more secure authentication processes.

### SUMMARY

These and other needs are addressed by the various embodiments and configurations of the present disclosure. The present disclosure can provide a number of advantages depending on the particular configuration. These and other advantages will be apparent from the disclosure contained herein.

A request is received, from a user, to access a first level authentication service (e.g., the user's bank). A code associated with the user is generated. For example, a QR code is generated. The generated code associated with a user causes a redirection to a second level authentication service. The generated code associated with the user is sent (e.g., to a first communication device of the user). The user is authenticated based on a valid authentication credential of the user. Authenticating the user based on the valid authentication credential is accomplished at one of: the first level authentication service or the second level authentication service. At the first level authentication service, a message is received from the second level authentication service. The message sent from the second level authentication service is sent in response to the second level authentication service validating the generated code associated with user. In response to authenticating the user based on receiving the message from the second level authentication service, access is allowed, by the user to a resource.

The phrases “at least one”, “one or more”, “or,” and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C”, “A, B, and/or C”, and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

The terms “determine,” “calculate” and “compute,” and variations thereof, as used herein, are used interchangeably, and include any type of methodology, process, mathematical operation, or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

### BRIEF DESCRIPTION OF THE DRAWINGS

FIG. 1 is a block diagram of a first illustrative system for using codes to provide more secure authentication.

FIG. 2 is a flow diagram of a process for using codes to provide more secure authentication where the authentication takes place in a second level authentication service using a redirection.

FIG. 3 is a flow diagram of a process for using codes to provide more secure authentication where the authentication takes place in a second level authentication service using a direct connection.

FIG. 4 is a flow diagram of a process for using codes to provide more secure authentication where the authentication takes place in a first level authentication service.

FIG. 5 is a flow diagram of a process for using codes to provide more secure authentication where the authentication takes place in a first level authentication service and a second level authentication service.

FIG. 6 is a diagram of an exemplary QR code and a description of information in the QR code.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

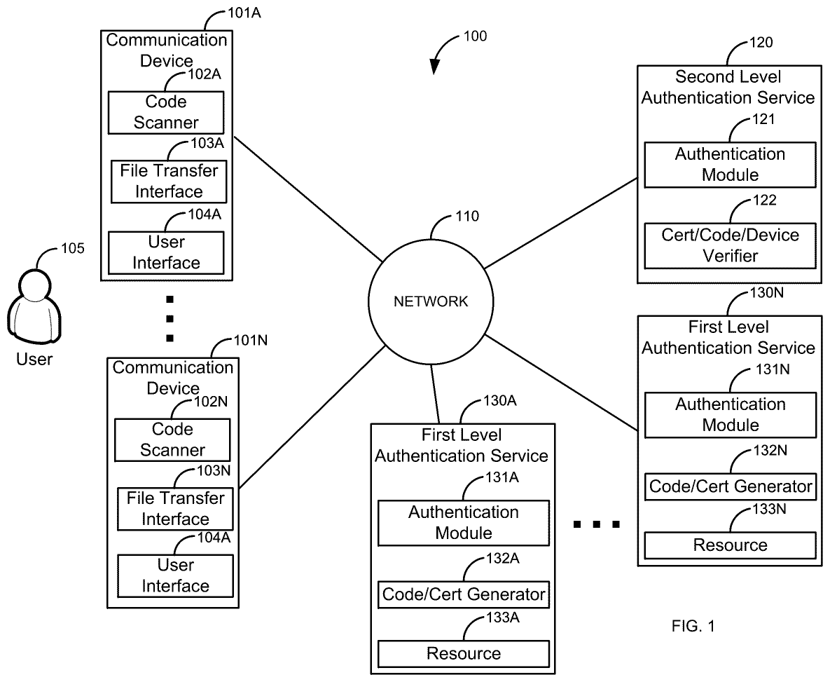

FIG. 1 is a block diagram of a first illustrative system 100 for using codes to provide more secure authentication. The first illustrative system 100 comprises communication devices 101A-101N, a network, a second level authentication service 120, and first level authentication services 130A-130N. In addition, a user 105 is shown for illustrative purposes.

The communication devices 101A-101N can be or may include any user device that can communicate on the network 110, such as a Personal Computer (PC), a telephone, a video system, a cellular telephone, a Personal Digital Assistant (PDA), a tablet device, a notebook device, a smartphone, a laptop computer, an Automated Teller Machine (ATM), a code reader, an access panel, an embedded device, and/or the like. As shown in FIG. 1, any number of communication devices 101A-101N may be connected to the network 110. The communication devices 101A-101N comprise code scanners 102A-102N, file transfer interfaces 103A-103N, and user interfaces 104A-104N.

The code scanners 102A-102N may be any device that can be used to scan a code, such as a barcode scanner, a Quick Response (QR) code scanner, a camera, a handheld scanner, and/or the like. The code scanners 102A-102N are used to scan the codes. A code may be any type of code that can be scanned, such as a barcode, a QR code, a color QR code, a code embedded into an image, and/or the like.

The file transfer interfaces 103A-103N may be an interface that can be used to transfer a code that can be used to redirect a communication session, such as a Near Field Communication (NFC) interface, a Bluetooth interface, a WiFi interface, and/or the like. The file transfer interfaces 103A-103N are typically short-range interfaces that can be used to transfer a code locally.

The user interfaces 104A-104N are graphical user interfaces that allow a user 105 to view information, such as a Light Emitting Diode (LED) display, a plasma display, a liquid crystal display, a cathode ray tube, and/or the like. The user interfaces 104A-104N are used by the user 105 to authenticate and access the resources 133A-133N.

The network 110 can be or may include any collection of communication equipment that can send and receive electronic communications, such as the Internet, a Wide Area Network (WAN), a Local Area Network (LAN), a packet switched network, a circuit switched network, a cellular network, a combination of these, and the like. The network 110 can use a variety of electronic protocols, such as Ethernet, Internet Protocol (IP), Hyper Text Transfer Protocol (HTTP), Web Real-Time Protocol (Web RTC), and/or the like. Thus, the network 110 is an electronic communication network configured to carry messages via packets and/or circuit switched communications.

The first level authentication services 130A-130N are authentication services provided by an entity. For example, an entity may be a corporate entity, a partnership, an enterprise, a business, an organization, and/or the like. The first level authentication services 130A-130N are used by the entities to authenticate a user 105 and to provide access resource(s) 133 controlled by the entity. The first level authentication services 130A-130N may use a variety of authentication process/credentials to authenticate the user 105, such as a username/password, a fingerprint scan, an iris scan, a security question, a voiceprint, Short Message Service (SMS) codes, Quick Response (QR) codes, email codes, credit cards, a Personal Identification Number (PIN), digital certificates, device tokens, IP addresses, and/or the like. The first level authentication services 130A-130N further comprise authentication modules 131A-131N, code/certificate generators 132A-132N, and resources 133A-133N.

The authentication modules 131A-131N are used to authenticate the user 105 to the resrouces 133A-133N. The authentication modules 131A-131N use the code/certificate generators as part of the authentication process. The authentication modules 131A-131N validate the different authentication credentials provided by the user 105.

The code/certificate generators 132A-132N are used to generate codes, such as a barcode, a QR code, a color QR code, a code in an image, and/or the like. The code/certificate generators 132A-132N are used to generate and codes. For example, a certificate may be a signed digital certificate that is signed using public/private encryption keys.

The resources 133A-133N are anything that can be accessed by the user 105 based on an electronic authentication, such as a database, a social network, a software application, an embedded device, a building, a network 110, a website, and/or the like. The resources 133A-133N may be controlled by different entities or the same entity. Access to the resources 133A-133N may be different based on authentication levels of the user 105. For example, a first level authentication (e.g., a username/password and QR code) may grant access to a resource 133 and a second level authentication (username/password, fingerprint scan, and QR code) may not only grant the user 105 access to the resource 133 but may also grant the user 105 the ability to administer the resource 133.

The second level authentication service 120 is typically an authentication service controlled by a third-party. The third-party is an entity that is typically separate from the entities that control the first level authentication services 130A-130N. The second level authentication service 120 works in conjunction with first level authentication services 130A-130N to authenticate the user 105 for accessing the resources 133A-133N. The second level authentication service 120 further comprises an authentication module 121 and a certificate/code/device verifier 122.

The authentication module 121 is similar to the authentication modules 131A-131N. The authentication module 121 uses various authentication processes to authenticate the user 105.

The certificate/code/device verifier 122 is used to verify digital certificates, codes, device tokens, IP addresses, network addresses, location information, and/or the like as part of the authentication process. The certificate/code/device verifier 122 is used by the authentication module 121 as part of the authentication process.

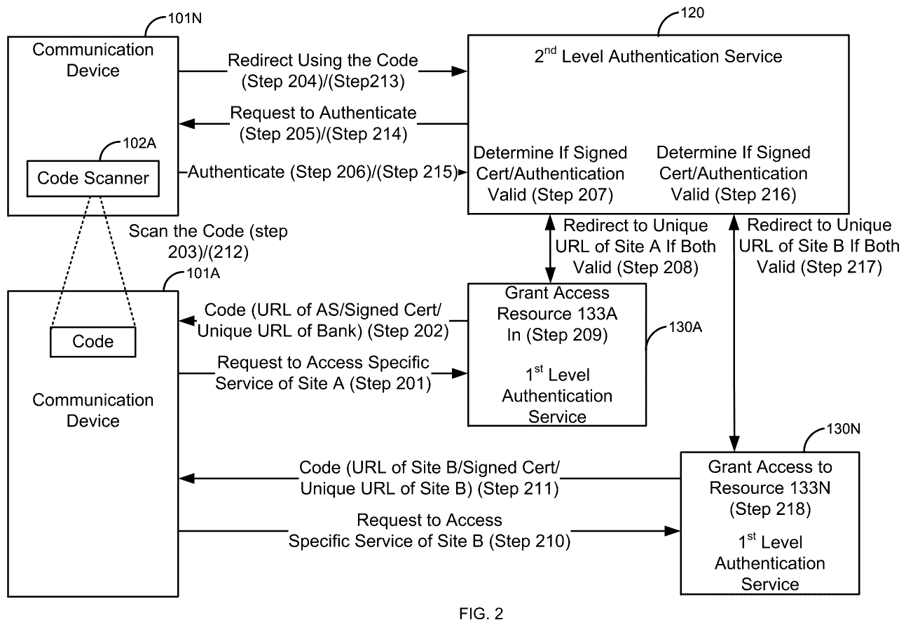

FIG. 2 is a flow diagram of a process for using codes to provide more secure authentication where the authentication takes place in a second level authentication service 120 using a redirection. Illustratively, the communication devices 101A-101N, the code scanners 102A-102N, the file transfer interfaces 103A-103N, the user interfaces 104A-104N, the second level authentication service 120, the authentication module 121, the certificate code/device verifier 122, the first level authentication services 130A-130N, the authentication modules 131A-131N, the code/certificate generators 132A-32N, and the resources 133A-133N are stored-program-controlled entities, such as a computer or microprocessor, which performs the method of FIGS. 2-6 and the processes described herein by executing program instructions stored in a computer readable storage medium, such as a memory (i.e., a computer memory, a hard disk, and/or the like). Although the methods described in FIGS. 2-6 are shown in a specific order, one of skill in the art would recognize that the steps in FIGS. 2-6 may be implemented in different orders and/or be implemented in a multi-threaded environment. Moreover, various steps may be omitted or added based on implementation.

FIG. 2 uses scannable codes as an additional part of the authentication process to make the authentication process more secure. While a QR code is described in FIGS. 2-6, any type of scannable code can be used, such as a barcode, a color QR code, a code in an image, a number code, a Radio Frequence Identification (RFID) tag, and/or the like. In addition, instead of using the code scanner 102, the code can be passed via the file transfer interface 103. For example, a QR code may be passed using Bluetooth from one communication device 101 to another communication device 101.

The process starts in step 201 where the user 105 requests, from the communication device 101A, to access the resource 133A (e.g., a banking account of the user's bank). The request may include a device token, an IP address (or any address), location information associated with the communication device 101A, and/or the like. A device token is a unique identifier of the communication device 101A. The user 105 may provide an authentication credential (e.g., username). In response to the request, this causes the generation of a QR code that has a redirection URL to the second layer authentication service 120. The QR code may also contain, a code identifier, a signed certificate (e.g., a signed certificate/timestamp), the username, a service identifier, a first level authentication service URL, a device token, location information, and/or the like. The first level authentication service URL is a specific link for the user 105 and what resources 133 the user 105 can access at the first level authentication service 130A. The code identifier may identify the type of code (e.g., a barcode). The signed certificate may be a digitally signed certificate that is specific to the user 105. The username may be the username provided by the user 105 in the request to authenticate at the first level authentication service 130A. The device token is a unique identifier of the communication device 101 (e.g., a generated token, an IP address, and/or the like). The service identifier is used to identify what services (e.g., resources 133) the user 105 can access. These fields may be encrypted in the QR code.

The QR code is then sent to the communication device 101A in step 202. The user 105 then scans the QR code from a communication device 101N in step 203. The scanning of the QR code redirects the user 105 on the communication device 101N to the second level authentication service 120 in step 204. The second level authentication service 120 (e.g., the certificate/code/device verifier 122) may validate the QR code, the digital certificate, the device token, IP address, location information, etc. If valid, the user 105 is requested to authenticate in step 205. Step 205 may also include a device token of the communication 101N, location information of the communication device 101N, an IP address of the communication device 101N, and/or the like. If there is a username in the QR code, the user 105 may only be asked for their password (assuming that a username is required). The user 105 then authenticates (e.g., using a password and other credentials if required) in step 206.

The authentication module 121 determines if the digital certificate, authentication credentials, device token(s), location information, IP addresses, and/or the like (in the code) are valid in step 207. If the first level authentication service URL (or any of the fields) are encrypted, the authentication module 121 unencrypts the first level authentication service URL. If everything is valid, the second level authentication service 120 is redirected (e.g., using an TLS connection that is established) to the first level authentication service 130A by using the first level authentication service URL from the scanned QR code in step 208. For example, the redirection may include a message that indicates (either directly or implicitly) that the QR code is valid, the signed certificate is valid, the IP addresses are valid, the location information of the communication devices 101A/101N is valid, and/or the like. In one embodiment, step 207 may also compare the IP address of the communication device 101A (sent with the QR code) to the IP address of the communication device 101N received in step 204 to make sure they are different. In other words, the comparison is to validate that there are two different communication devices 101 being used as part of the authentication process. The comparison may also consider known IP addresses of the user's communication devices 101. The user 105 can the access the resource 133A in step 209.

In addition to comparing IP address, the QR code may include location information of the communication device 101A. For example, the request to access of step 201 may include location information of the communication device 101A, which is then placed into the QR code sent in step 202. Likewise, the communication device 101N may send location information in either steps 204 or 206. The location information can then be compared to known location information associated with the user's communication devices 101A/101N to determine if the user 105 is in a non-approved location and/or is using a non-approved IP address. In one embodiment, this information could be flagged as an anomalous behavior of the user 105 for monitoring by a security analyst and/or blocking access of the user 105 to the resource 133A.

What is accessed may depend upon the first level authentication service URL (or part of the signed cert). For example, the user 105 may only want to view the bank account versus withdrawing from the account. In addition, based on the digital certificate, different authentication credentials may be required in step 206. For example, if the user 105 wants only to view the bank account, the user 105 may only have to provide a username/password. In this example, the digital certificate will include access information and required authentication credentials/levels. If the user 105 wants to withdraw from the account, a username/password and a fingerprint scan may be required in step 206. As shown in FIG. 2, this process can be repeated if the user 105 wants to access the resource 133N in steps 210-218.

In one embodiment, if single-sign-on is enabled, the user 105 will go to the first level authentication service 130N using a simplified process. Once the user 105 requests access to the specific service in step 210, the second QR code is generated and sent in step 211. The user 105 scans the second QR code in step 212, which redirects the user to the second level authentication service 120 in step 213. Because the user 105 has already authenticated (i.e., still currently authenticated) in step 206, the user 105 will automatically be redirected to the first level authentication service 130N (assuming the digital certificate in the second QR code has been validated). In other words, there is a single sign-on process with a unique QR code for each of the first level authentication services 130A/130N. In this embodiment, there may be two concurrent connections to the first level authentication services 130A/130N from the second level authentication service 120. In order to make sure that a hacker cannot hack the first level authentication service 130N while the user 105 is authenticated to first level authentication service 130A, a device token (e.g., a signed token) and/or digital certificate may be required to be presented by both the communication devices 101A/101N in order to resources 133A/133N.

To illustrate, consider the following example of FIG. 2. The user 105 wants to access a website (the first level authentication service 130A). The user 105 goes to the website to login and provides their username using the communication device 101A (the user's PC). The QR code is generated (that includes the redirection URL, the username, and the first level authentication service URL). The QR code is displayed on the PC. The user 105, from their smartphone (the communication device 101N) scans the QR code on the PC and gets redirected to the 2^{nd} level authentication service 120. The user 105 then enters the user's password at the second level authentication service 120 (the username is not needed because it is in the QR code). The user 105 is then redirected to the first level authentication service 130A to access the resource 133A.

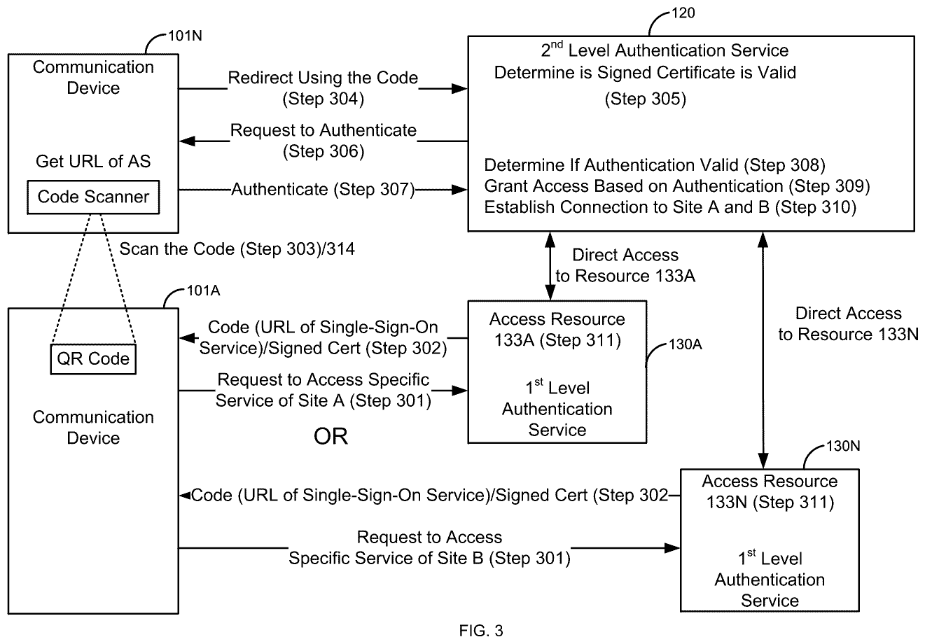

FIG. 3 is a flow diagram of a process for using codes to provide more secure authentication where the authentication takes place in a second level authentication service 120 using a direct connection (but could also be a redirect). In the second embodiment, as shown below in FIG. 3, a single scannable QR code can be used as part of a single-sign-on process for multiple sites.

The user 105 tries to authenticate with a username at either of the first level authentication service 130A or the first level authentication service 130N in step 301. In response to the authentication attempt (or just going to either of the first authentication services 130A/130N based on a device toekn), the user 105 is sent a scannable QR code in step 302. The scannable QR code may or may not include a signed certificate, the username (which may be encrypted), an IP address of the communication device 101A (which may also be encrypted), a device ID, (which may also be encrypted) and/or location information (which may also be encrypted). The signed certificate may also include a timestamp. The user 105, from the communication device 101N, scans the QR code in step 303. The scanning of the QR code in step 303 redirects the user 105 to the second level authentication service 120 in step 304. If a signed certificate is included in the QR code, the signed certificate is validated in step 305. Also, if an IP address/device tokens/location information are in the QR code, the IP address from the communication device 101A may be compared to the IP address of the communication device 101N to make sure they are different (e.g., from known IP addresses of the user's communication devices 101). In addition, the location information may be compared in the same manner described in FIG. 2. Validation is considered to be validation of anything in the code.

If the certificate/IP addresses/locations are valid, the user 105 is presented with a request to authenticate in step 306. The user 105 then authenticates in step 307 (if the username is in the QR code, only a password would be required for a username/password) using the required credential(s). The second level authentication service 120 determines if the authentication is valid in step 308. If the authentication is valid in step 308, access is granted to the resource 133 in step 309. Communication sessions are established to both the resources 133A/133N in step 310 (assuming the user 105 can access both based on the provided authentication credentials). The establishment of the communication sessions may include a message that indicates (either directly or implicitly via the connection) that the authentication process was successful, that the QR code is valid, that the signed certificate is valid, location information is valid, and/or the like. The user 105 can then access the resources 133A/133N. The direct connections of step 310 can use the signed certificate (or could be a redirect). The first level authentication service 130N makes the connection based on the signed certificate provided by a certificate verification service by matching it to the signed certificate sent in the QR code of step 303 and the authentication provided in step 307.

To illustrate, consider the following example of FIG. 3. The user 105 wants to access two different software applications (the resources 133A/133N owned by the same entity). The user 105 goes to the website to login and access the first application (resource 133A) and provides their username using the communication device 101A (the user's PC). The QR code is generated (that includes the redirection URL, the username, and the first level authentication service URL). The QR code is displayed on the PC (the communication device 101A). The user 105, from their smartphone (the communication device 101N) scans the QR code and gets redirected to the 2^{nd} level authentication service 120 (a single sign-on service). The user 105 then enters the user's password at the second level authentication service 120 (the username is not needed because it is in the QR code). The user 105 is then connected to the first level authentication service 130A to access the resource 133A and to the first level authentication service 130N to access the resource 133N (assuming that the authentication credentials provided allow access to the resource 133N).

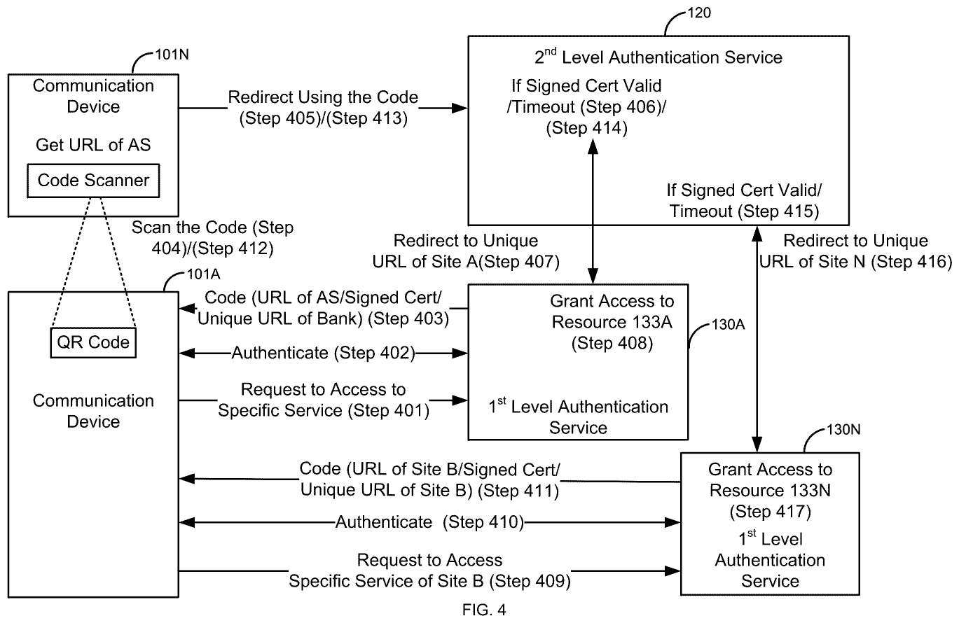

FIG. 4 is a flow diagram of a process for using codes to provide more secure authentication where the authentication takes place in a first level authentication service 130. In FIG. 4, instead of having a single-sign-on authentication service, a certificate verification service is used in place of the authentication process. In FIG. 4, the authentication is accomplished via each of the first level authentication services 130A-130N.

The user 105 requests access to a resource 133A in step 401. The user 105 authenticates in step 402 at the first level authentication service 130A. A QR code is generated and sent in step 403. The QR code may include a signed certificate and the redirection URL/first level authentication service URL (could also have the IP address/device token of the communication 101A device/location information). The signed certificate may also have a timestamp. The user 105 scans the QR code from the communication device 101N in step 404. The communication device 101N is redirected to the second level authentication service 120 in step 405 based on the redirection URL in the QR code.

The first level authentication service 130A determines, in step 406, if the signed certificate in the QR code is valid. If the signed certificate is valid in step 406, the user 105, at the communication device 101N, is redirected to the first level authentication service 130A based on the first level authentication service URL that is in the QR code in step 407. For example, the redirection may include a message that indicates (either directly or implicitly by sending the message) that the QR code is valid, which includes that the signed certificate is valid, that the location information is valid, and/or the like. The user 105 is then granted access to the resource 133A in step 408. If an IP address/device token/location information was in the QR code in step 405, the IP address/device token in the QR code may be compared to the IP address of the communication device 101N to make sure they are different. If there is location information, the location information can be used to determine if the user 105 is in an appropriate location. The redirection may include the signed certificate for validation of the redirection by the first level authentication service 130A.

If the user 105 wants to access the first level authentication service 130N/resource 133N, the user 105 requests to access the first level authentication service 130N in step 409. The user 105 authenticates in step 410. The first level authentication service 130N generates and sends a second QR code to the communication device 101A (with the same type of information or the information may be different based on implementation). The user 105 scans the second QR code in step 412. The user 105 is redirected to the second level authentication service 120 in step 413 (or could go back directly back to the first level authentication service 130N, which would determine if the certificate is valid). The second level authentication service 120 determines if the certificate is valid (and has not timed out) in step 414. If the signed certificate is valid in step 415, the user 105 is redirected to the first level authentication service 130N using the first level authentication service URL (that may have been encrypted) in step 416. The user 105 is then granted access to the resource 133N in step 417. The redirection may include the signed certificate for validation of the redirection and/or a device token.

To illustrate the process of FIG. 4, consider the following example. The user 105 goes to the website A using the communication device 101A and authenticates using a username/password. The website A (the first level authentication service 130A) authenticates the username/password. The website A sends the QR code to the communication device 101A that includes the signed certificate. The user 105 scans the QR code with their smartphone, which redirects the user 105 to second level authentication service 120. The second level authentication service 120 validates the signed certificate. The user 105 is then redirected or directly connected to the first level authentication service 130A so that the user 105 can access the resource 133A. The user 105 can then repeat the same process to access the resource 133N at website N.

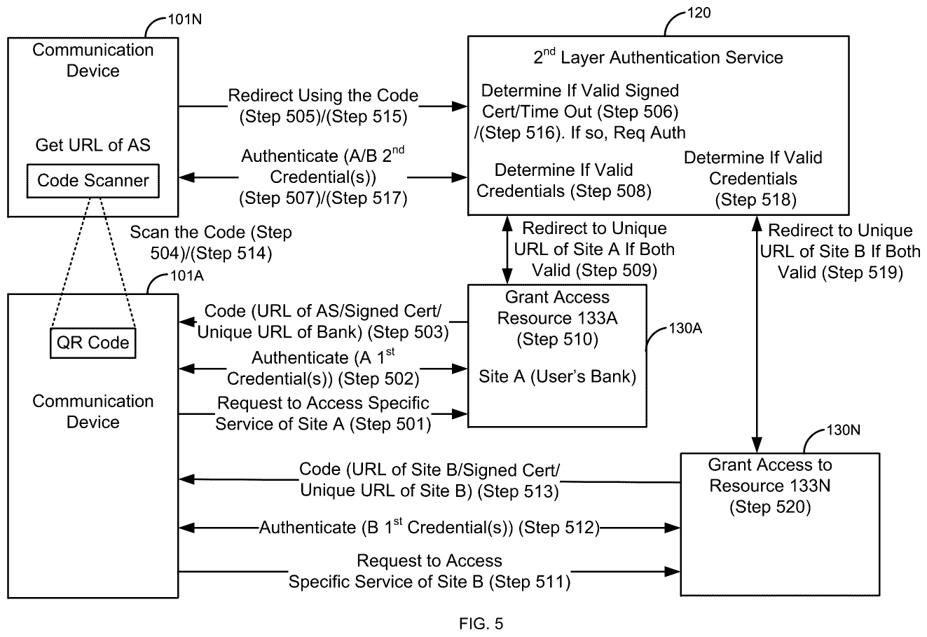

FIG. 5 is a flow diagram of a process for using codes to provide more secure authentication where the authentication takes place in a first level authentication service and a second level authentication service 120. FIG. 5 is an example of a two-level authentication process that uses scannable QR codes.

The user 105 requests to access a specific resource 133A in step 501. The user 105 provides a first level authentication credential(s) at the first level authentication service 130A in step 502. A QR code is generated and sent to the communication device 101A in step 503 (e.g., similar to the ones described above). The QR code is scanned, by the communication device 101N in step 504. The communication device 101N is redirected to the second level authentication service 120 in step 505.

The second level authentication service 120 determines if the signed certificate is valid in step 506. If the signed certificate is valid in step 506, the user 105 is requested to authenticate and authenticates with the second level authentication credentials in step 507. The second level authentication service 120 determines, in step 508, if the second level authentication credential(s) are valid. If the second level authentication credential(s) are valid in step 508, the communication device 101N is redirected to the first level authentication service 130A in step 509 and is granted access to the specific resource 133A in step 510. For example, the redirection may include a message that indicates (either directly or implicitly by sending the message) that the QR code is valid, which includes, that the signed certificate is valid, and/or the like. The user 105 is then granted access to the resource 133A in step 510. The redirection of step 510 may include the signed certificate.

Alternatively, instead of redirecting in step 510, a secure connection may be established from the second level authentication service 120 to the first level authentication service 130A. The second level authentication service 120 provides the signed certificate to validate the establishment of the connection. The first level authentication service 130A makes the connection based on the signed certificate provided by the second level authentication service 120 by matching it to the signed certificate sent in the QR code. The second level authentication service 120 may send an acknowledgement message that indicates the approval of the certificate.

For accessing the resource 133N, the user 105 repeats the same process in steps 511-520. This allows the user 105 to access the resource 133N.

To illustrate the process of FIG. 5, consider the following example. The user 105 goes to the ATM (the communication device 101A and provides a credit card (first authentication credential) and optionally a PIN. The bank (the first level authentication service 130A) authenticates the credit card/PIN. This causes the ATM to display the QR code. The user 105 scans the QR code with his/her smartphone, which redirects the user 105 to second level authentication service 120. The user 105 authenticates to the second level authentication service 120 (e.g., using a fingerprint scan) and then can make transactions (access the resource 133A (e.g., a bank account)). In addition, the second level authentication service 120 may validate a signed certificate (associated with the user 105) that was sent in the QR code.

The user 105 can then repeat the process by requesting access to the first level authentication service 130N (e.g., a website that sells goods) and completing steps 511-519. After completing the process, the user 105 can access the website that sells goods in step 520.

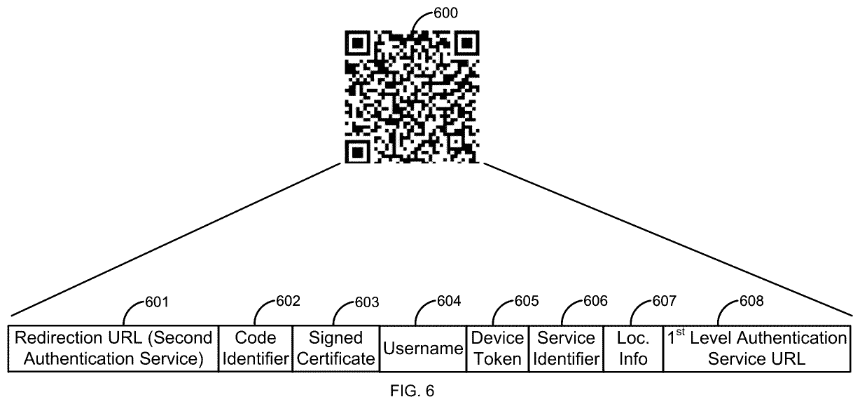

FIG. 6 is a diagram of an exemplary QR code 600 and a description of information in the QR code 600. While FIG. 6 is described with a QR code 600, other types of codes may be used. For example, any scannable code/passable code may be used that can accommodate the information in the QR code 600.

The QR code comprises fields 601-608 that includes the redirection URL 601, the code identifier 602, the signed certificate 603, the username 604, the device token 606, the service identifier 606, the location information 607, and the first level authentication service URL 608. While the QR code 600 is described with all the fields 601-608, the QR code 600 may comprise different combinations of the fields 601-608 based on implementation. For example, the QR code 600 may only comprise the redirection URL 601. Alternatively, in another embodiment, the QR code 600 may comprise the redirection URL 601, the signed certificate 603, the username 604, the device token 605, the location information 607, and the first level authentication service URL 608. In addition, any, or all of the fields 602-608 may be encrypted using any encryption mechanism.

The redirection URL 601 is used to redirect a communication device 101 to the second level authentication service 120. The code identifier 602 identifies a type of code. For example, the type of code may be a QR code, a barcode, a scannable image, a code specific to the second level authentication service 120, and/or the like. The signed certificate 603 is a digitally signed certificate that can be used to authenticate a user 105. The username 604 is a username that is part of an authentication credential (e.g., a username/password).

The device token 605 is a device token that is associated with a specific communion device. The device token 605 may be generated and sent to the communication device 101. The device token 605 may include IP address information, Media Access Control (MAC) address information, and/or the like. The service identifier 606 is associated with a specific authentication service. For example, the service identifier 606 may be specific to the first level authentication service 130A. The location information 607 is information associated with a location of a communication device 101. For example, the location information 607 may be location information 607 that is determined based on Global Positioning Satellite (GPS) information, IP address information, and/or the like.

The first level authentication service URL 608 is a URL that is associated with a first level authentication service 130. The first level authentication service URL 608 may comprise information that is used to identify a specific resource 133 and/or access privilege administer to a specific resource 133.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

Any of the steps, functions, and operations discussed herein can be performed continuously and automatically.

However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should however be appreciated that the present disclosure may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosure.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, sub combinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving case and/or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A system comprising:
a microprocessor; and
a computer readable medium, coupled with the microprocessor and comprising microprocessor readable and executable instructions that, when executed by the microprocessor, cause the microprocessor to:
receive a first request, from a user, to access a first, first level authentication service;
generate a first code associated with the user, wherein the generated first code associated with a user causes a redirection to a second level authentication service;
send the generated first code associated with the user;
authenticate the user based on a valid first authentication credential of the user, wherein authenticating the user based on the valid first authentication credential is accomplished at one of: the first, first level authentication service or the second level authentication service;
receive, at the first, first level authentication service, a first message from the second level authentication service, wherein the first message sent from the second level authentication service is sent in response to the second level authentication service validating the generated first code associated with user; and
in response to authenticating the user based on receiving the first message from the second level authentication service, allow access, by the user to a first resource.

2. The system of claim 1, wherein authenticating the user based on the valid first authentication credential of the user is accomplished at the first, first level authentication service.

3. The system of claim 1, wherein authenticating the user based on the valid first authentication credential of the user is accomplished at the second level authentication service.

4. The system of claim 1, wherein authenticating the user based on the valid first authentication credential of the user is accomplished at the first, first level authentication service and wherein the first message from the second level authentication service is sent, also based on a validation of a second authentication credential of the user received at the second level authentication service.

5. The system of claim 1, wherein authenticating the user based on the valid first authentication credential of the user is accomplished at the second level authentication service, wherein the first authentication credential of the user comprises a password provided by the user, wherein the generated first code associated with the user comprises a username provided when the user first requests the access the first, first level authentication service, and wherein validation of the first authentication credential of the user is based on the password provided by the user at the second level authentication service and the username in the generated first code associated with the user.

6. The system of claim 1, wherein the first message from the second level authentication service is sent, also based on a validation of a device token of a first communication device in the generated first code associated with the user and a device token of a second communication device.

7. The system of claim 1, wherein the generated first code is a Quick Response (QR) code that comprises a signed certificate that is validated by the second level authentication service.

8. The system of claim 7, wherein the signed certificate includes information that defines what the user can access and/or administer in the first resource.

9. The system of claim 1, wherein the microprocessor readable and executable instructions further comprise instructions to:
receive a second request to authenticate at a second, first level authentication service;
generate a second code associated with the user, wherein the generated second code associated with the user causes a redirection to the second level authentication service;
send the generated second code associated with the user;
authenticate the user based on a valid second authentication credential of the user, wherein authenticating the user based on the valid second authentication credential of the user is accomplished at one of: the first, first level authentication service or the second level authentication service;
receive, at the second, first level authentication service, a second message from the second level authentication service, wherein the second message sent from the second level authentication service is sent in response to the second level authentication service validating the generated second code associated with user; and
in response to authenticating the user based on receiving the second message from the second level authentication service, allow access, by the user, to a second resource.

10. The system of claim 9, wherein authenticating the user based on the valid first authentication credential of the user is accomplished at the first, first level authentication service, wherein authenticating the user based on the valid second authentication credential of the user is accomplished at the second, first level authentication service, wherein the first message sent from the second level authentication service is sent, also based on a validation of a third authentication credential of the user received at the second level authentication service, and wherein the second message sent from the second level authentication service is sent, also based on a validation of a fourth authentication credential of the user received at the second level authentication service.

11. The system of claim 9, wherein authenticating the user based on the valid first authentication credential of the user is accomplished at the first, first level authentication service, wherein authenticating the user based on the valid second authentication credential of the user is accomplished at the second, first level authentication service, wherein the first message sent from the second level authentication service and the second message sent from the second level authentication are sent, also based on a validation of a third authentication credential of the user received at the second level authentication service.

12. The system of claim 1, wherein the access to the first resource is based on a redirection from the second level authentication service to the first, first level authentication service and wherein the redirection from the second level authentication service to the first, first level authentication service is based on a redirection Uniform Resource Locator (URL) in the generated first code associated with the user and/or a service identifier.

13. The system of claim 12, wherein the redirection URL comprises information that defines what the user can access and/or administer in the first resource.

14. The system of claim 1, wherein the first code comprises location information of a first communication device of the user and wherein the location information of the first communication device is used as part of authenticating the user.

15. The system of claim 1, wherein the first resource is controlled by a first entity, wherein in response to authenticating the user based on receiving the first message from the second level authentication service, access is also allowed, by the user, to a second resource controlled by a second entity.

16. A method comprising:
receiving, by a microprocessor, a first request, from a user, to access a first, first level authentication service;
generating, by the microprocessor, a first code associated with the user, wherein the generated first code associated with a user causes a redirection to a second level authentication service;
sending, by the microprocessor, the generated first code associated with the user;
authenticating, by the microprocessor, the user based on a valid first authentication credential of the user, wherein authenticating the user based on the valid first authentication credential is accomplished at one of: the first, first level authentication service or the second level authentication service;
receiving, by the microprocessor, at the first, first level authentication service, a first message from the second level authentication service, wherein the first message sent from the second level authentication service is sent in response to the second level authentication service validating the generated first code associated with user; and
in response to authenticating the user based on receiving the first message from the second level authentication service, allowing access by the microprocessor, by the user to a first resource.

17. The method of claim 16, wherein authenticating the user based on the valid first authentication credential of the user is accomplished at the first, first level authentication service and wherein the first message from the second level authentication service is sent, also based on a validation of a second authentication credential of the user received at the second level authentication service.

18. The method of claim 16, wherein authenticating the user based on the valid first authentication credential of the user is accomplished at the second level authentication service, wherein the first authentication credential of the user comprises a password provided by the user, wherein the generated first code associated with the user comprises a username provided when the user first requests the access the first, first level authentication service, and wherein validation of the first authentication credential of the user is based on the password provided by the user at the second level authentication service and the username in the generated first code associated with the user.

19. The method of claim 16, further comprising:
receiving, by the microprocessor a second request to authenticate at a second, first level authentication service;
generating, by the microprocessor, a second code associated with the user, wherein the generated second code associated with the user causes a redirection to the second level authentication service;
sending, by the microprocessor the generated second code associated with the user;
authenticating, by the microprocessor, the user based on a valid second authentication credential of the user, wherein authenticating the user based on the valid second authentication credential of the user is accomplished at one of: the first, first level authentication service or the second level authentication service;
receiving, by the microprocessor, at the second, first level authentication service, a second message from the second level authentication service, wherein the second message sent from the second level authentication service is sent in response to the second level authentication service validating the generated second code associated with user; and
in response to authenticating the user based on receiving the second message from the second level authentication service, allowing access, by the microprocessor, by the user, to a second resource.

20. A non-transient computer readable medium having stored thereon instructions that cause a processor to execute a method, the method comprising instructions to:
receive a request, from a user, to access a first, first level authentication service;
generate a first code associated with the user, wherein the generated first code associated with a user causes a redirection to a second level authentication service;
send the generated first code associated with the user;
authenticate the user based on a valid first authentication credential of the user, wherein authenticating the user based on the valid first authentication credential is accomplished at one of: the first, first level authentication service or the second level authentication service;
receive, at the first, first level authentication service, a first message from the second level authentication service, wherein the first message sent from the second level authentication service is sent in response to the second level authentication service validating the generated first code associated with user; and
in response to authenticating the user based on receiving the first message from the second level authentication service, allow access, by the user to a first resource.
